(19) United States
(12) Patent Application Publication
(10) Pub. No.: US 2024/0158995 A1
(43) Pub. Date: May 16, 2024

(54) SQUARE EDGE RECESSED LUG PAVER

(71) Applicant: Endicott clay Products Company, Endicott, NE (US)

(72) Inventors: Ryan Parker, Lincoln, NE (US); George Firmanik, Fairbury, NE (US)

(21) Appl. No.: 18/388,069

(22) Filed: Nov. 8, 2023

Related U.S. Application Data
(60) Provisional application No. 63/424,469, filed on Nov. 10, 2022.

(51) Int. Cl. E01C 5/00

(52) U.S. Cl. CPC E01C 5/005; E01C 2201/02

(57) ABSTRACT

A square edge recessed lug paver having recessed lugs that produce consistent joint size during installation without the use of additional pieces of equipment, while maintaining a square edge is described. The equipment and method to produce the square edge recessed lug paver is also described, where the recessed lug roller forms the recessed lugs of the square edge recessed lug pavers. The recessed lug roller includes at least one recessed portion and at least two compressing portions. The recessed lugs are formed on an uncut slug after extrusion of the slug.

This application claims the benefit of U.S. Provisional Application No. 63/424,469 entitled “SQUARE EDGE RECESSED LUG PAVER” filed Nov. 10, 2022, which is incorporated by reference in its entirety.

### BACKGROUND

Clay pavers are a conventional and popular option for paving walkways, roads, patios, driveways, and the like. When installed appropriately, clay pavers provide durability and aesthetic advantages over concrete and natural stone pavers. Clay pavers may be formed through extrusion, soft-mud, or dry-press. Extruded pavers provide advantages over soft-mud and dry-press pavers of a higher compressive strength, lower absorption, can be manufactured much more efficiently, offer better dimensional tolerance, and allows a wider range of clay types to be used in forming.

Conventional installation methods for clay pavers include setting in a sand setting bed. In a sand setting bed interlock of pavers is particularly important, where individual pavers are held in position by the frictional interlock in each sand-filled joint between adjacent pavers. The joints transfer vertical and horizontal forces, and can also accommodate expansion and contraction of the individual pavers. If these forces cause slight deflection, the pavers will realign themselves to the new profile without significant loss in structural capacity. Interlock is developed by (1) properly sized joints (i.e. distance between adjacent pavers), and (2) the sand that fills the joints. Sand setting beds may be installed directly on an aggregate base, asphalt base, cement-treated aggregate base or concrete base.

Sand-set pavers interlock with one another by generating friction across the joints, which is the result of tightly packing sand into where the pavers are subject to vibration. The interlock improves as the pavement is subjected to traffic as this provides additional vibration to the pavers. Interlocked pavers cannot be readily extracted from their setting. There are three types of interlock present in a sand-set pavers when properly constructed: vertical, horizontal, and rotational interlock.

Vertical interlock provides load transfer across joints between adjacent pavers. When a load is applied to one paver, a portion is transferred through sand in the joints to adjacent pavers to distribute the load to a greater area. This reduces stress on the sand bed and the underlying layers. Vertical interlock causes the paver layer to act as a structural layer. Without vertical interlock, the pavers do not act as a structural layer, and force is localized on the setting bed directly under a loaded paver, which can result in pavers being pushed downward into the sand setting bed.

Rotational interlock prevent rotation of pavers and is the result of lateral resistance from adjacent pavers and adequate edge restraints (e.g. concrete curbs, precut stone, and the like). It is improved with proper joint size, where with inadequate edge restraint and improper joint size, the pavers can rotate in the direction of lateral force. Finally, horizontal interlock reduces movement of pavers laterally, where the extent of horizontal interlock depends upon the laying (bond) pattern of the pavers and the edge restraint, where patterns with staggered joint lines yield better horizontal interlock.

As noted, installing pavers in a sand setting bed to achieve vertical, rotational, and horizontal interlock requires appropriate joint size. A joint size that is too large does not produce sufficient interlocking leading to improper load transfer and damage to individual pavers as well as shifting in the paver setting pattern. A joint size that is too small produces chipping and damage to adjacent pavers, as the pavers contact each other when load is transferred between pavers. Conventional methods for installing pavers while maintaining desired joint size depend on the paver type.

A conventional paver type is a straight edge paver 70, which is a rectangle shape with straight edges as shown in FIG. 1a. Maintaining appropriate joint size while setting straight edge pavers is achieved through manual placement and estimating the joint size based on the expertise of the individual laying the pavers. Use of a conventional square edge paver with this installation method is time consuming and does not produce consistent joint sizes between adjacent pavers, as the joint size is estimated. Excessive spacing between pavers may lead to insufficient interlock and premature damage of the clay pavers. Joint size that are too small will lead to significant chipping as the paver edges come into contact with each other.

An alternative method of installing conventional square edge pavers is the use of plastic paver spacers. The plastic paver spacers are placed at the edge of pavers, where the spacer is equal to the desired joint size, so placement of the adjacent pavers with the desired joint size is achieved. While this method using the conventional square edge paver produces more consistent joint size, it has the drawback of being time consuming and requires additional pieces of equipment (i.e. the plastic paver spacers themselves) for installation.

Another conventional paver is a square edge lugged paver 80, which is rectangle in shape with lugs on the edges, where the lugs run the full height of the paver as shown in FIG. 1b. Maintaining desired joint size with conventional square edge lugged pavers is achieved through manual placement of (1) an edge of the paver not having lugs flush with a lugged side of a second paver, or (2) the width edge of a paver having a lug with the lugged side of a second paver in an offset pattern, such that the lugs do not contact one another. While this conventional square edge lugged paver provides consistent joint size, the lugs are susceptible to peeling, where the lug peels off of the face of the paver creating a chipped area, as they extend the entire height of the paver to the exposed surface of the paver once installed. Additionally, square edge lugged pavers have the aesthetic drawback due to the full lugs that the lugs are visible from the surface when the paver is installed.

Another conventional paver is a relieved edge lugged paver 90, which is rectangle in shape with the surface of the paver having a relieved edge, where lugs extend the height of the paver, up to the relieved edge at the top of the paver as shown in FIG. 1c. Maintaining desired joint size with conventional relieved edge lugged pavers is achieved through manual placement of (1) an edge of the paver not having lugs flush with a lugged side of a second paver, or (2) the width edge of a paver having a lug with the lugged side of a second paver in an offset pattern, such that the lugs do not contact one another. While this conventional relieved edge lugged paver provides consistent joint size and reduces the likelihood of the lugs chipping as they do not extend to the exposed surface of the paver, the aesthetic of the relieved edge is not preferred because the edge created is not square due to the relief edge. Moreover the relieved edge does not provide a level plane due to the reliefs on the pavers. This un-level plane is less conducive for walking, in particular, when shoes such as high heels are worn. Because of the heel on this type of footwear coupled with the un-level surface, the chances of stepping on or in a relief of the paver are increased, where this may cause injury to the individual.

Therefore it is desirable to have an extruded clay paver that has structural characteristics that produce a desired and consistent joint size without the use of additional equipment for achieving joint size. It is further desirable to have an extruded clay paver with a structure that minimizes time in installation, while achieving a desired and consistent joint size. Finally, it is desirable to have an extruded clay paver with a structure that achieves a conventional square edge paver aesthetic and level plane while achieving a desired and consistent joint size during and after installation.

### SUMMARY

In aspects, a square edge recessed lug paver for maintaining proper joint size in any bonding pattern, the square edge recessed lug paver including at least five recessed lugs formed on the square edge recessed lug paver, each recessed lug including a depth equal to a proper joint size, a base from 0.3175 to 1.111 centimeters, a height that maintains proper joint size and is not visible when the square edge recessed lug paver is installed; and a shape that does not damage an adjacent square edge recessed lug paver and enhances safety during installation; a height of from 2.54 to 10.16 centimeters; a width; a length; a lugged side, the lugged side having a number of recessed lugs as calculated by a first recessed lug equation, where the recessed lugs of the lugged side are positioned horizontally along the lugged side such that at least one recessed lug will contact at least one adjacent square edge recessed lug paver and will not contact recessed lugs of a first and second width side of adjacent square edge recessed lug pavers when installed; a first width side, the first width side having a number of recessed lugs as calculated by a second recessed lug equation; a second width side, the second width side having a number of recessed lugs as calculated by the second recessed lug equation, wherein the recessed lug(s) of the first width side are placed horizontally along the first width side in a mirror location to the placement of the recessed lug horizontally along the second width side; and wherein the recessed lugs are centered vertically along the lugged side, the first width side, and the second width side; a non-lugged side, the non-lugged side containing no recessed lugs.

In aspects, the square edge recessed lug paver of paragraph [0012], wherein the height is from 3.81 to 10.16 centimeters, and the recessed lug height is equal to one third of the height.

In aspects, the square edge recessed lug paver of paragraph [0012], wherein the height is from 2.54 to 10.16 centimeters and the recessed lug height is within 0.3175 centimeters from a top of the square edge recessed lug paver to 0.3175 centimeters from a bottom of the square edge recessed lug paver.

In aspects, the square edge recessed lug paver of paragraph [0012], wherein the height is from 3.81 to 10.16 centimeters and the recessed lug height is 1.27 centimeters from a top of the square edge recessed lug paver to 1.27 centimeters from a bottom of the square edge recessed lug paver.

In aspects, the square edge recessed lug paver of paragraph [0012], wherein the width to length ratio is 1:1.

In aspects, the square edge recessed lug paver of paragraph [0016], wherein the width and length are 20.32 centimeters, and wherein the lugged side has three recessed lugs and the first and second width sides each have two recessed lugs.

In aspects, the square edge recessed lug paver of paragraph [0012], wherein the width to length ratio is 1:2.

In aspects, the square edge recessed lug paver of paragraph [0018], wherein the width is 10.16 centimeters and the length is 20.32 centimeters, and wherein the lugged side has three recessed lugs and the first and second sides each have one recessed lug.

In aspects, the square edge recessed lug paver of paragraph [0012], wherein the width to length ratio is 1:3.

In aspects, the square edge recessed lug paver of paragraph [0020], wherein the width is 10.16 centimeters and the length is 30.48 centimeters, and wherein the lugged side has four recessed lugs and the first and second sides each have one recessed lug.

In aspects, the square edge recessed lug paver of paragraph [0012], wherein the width to length ratio is 1:4.

In aspects, the square edge recessed lug paver of paragraph [0022], wherein the width is 10.16 centimeters and the length is 40.64 centimeters, and wherein the lugged side has five recessed lugs and the first and second sides each have one recessed lug.

A recessed lug roller that forms recessed lugs on square edge recessed lug pavers, the recessed lug roller including at least one roller section, the at least one roller section having a length equal to a height of the green square edge recessed lug paver, the at least one roller section including a first compression portion and a second compression portion that compress full lugs of a green square edge recessed lug paver; a recessed portion configured for forming recessed lugs of the square edge recessed lug paver where the recessed lug when green is not compressed by the recessed portion, the recessed portion including an opening equal to the height of the recessed lugs when green; a depth to accommodate the depth of the recessed lugs when green; and a shape to accommodate the shape of the recessed lug when green; and two clearance sections on each end of the recessed lug roller; and a shaft configured to allow the recessed lug roller to move in a circular motion across an uncut slug, where a first side and second side of the shaft are configured for attachment to a drive mechanism.

In aspects, the recessed lug roller of paragraph [0024], further including two or more roller sections, where a first compression portion of a first roller section is fabricated to a second compression portion of a second roller section.

In aspects, the recessed lug roller of paragraph [0024], further including thirty-nine roller sections, where each first compression portion is fabricated to a second compression portion of an adjacent roller section.

In aspects, the recessed lug roller of paragraph [0024], wherein the recessed portion has a tapered shape that tapers at a 90 degree angle from the opening of the recessed portion.

In aspects, the recessed lug roller of paragraph further including adjustable support brackets, where two rollers sections at locations one-third and two-thirds along the recessed lug roller are configured for attachment of the adjustable support brackets.

A method of forming a square edge recessed lug paver without use of additional pieces of equipment, the method including tempering clay to produce a homogenous, plastic clay mass; extruding the homogenous, plastic clay mass through a die having lugs to produce a fully lugged slug; forming recessed lugs on the fully lugged uncut slug; cutting the uncut slug having recessed lugs to produce green, square edge recessed lug pavers having recessed lugs; drying the green square edge recessed lug clay pavers; firing the square edge recessed lug clay paver to produce square edge recessed lug pavers.

In aspects, the method of paragraph [0029], wherein the recessed lug roller includes at least one roller section, the at least one roller section having a length equal to a height of the green square edge recessed lug paver, the at least one roller section including a first compression portion and a second compression portion that compress full lugs of a green square edge recessed lug paver; a recessed portion configured for forming recessed lugs of the square edge recessed lug paver where the recessed lug when green is not compressed by the recessed portion, the recessed portion including an opening equal to the height of the recessed lugs when green; a depth to accommodate the depth of the recessed lugs when green; and a shape to accommodate the shape of the recessed lug when green; and two clearance sections on each end of the recessed lug roller; and a shaft configured to allow the recessed lug roller to move in a circular motion across the green square edge recessed lug pavers, where a first side and a second side of the shaft are configured for attachment to a drive mechanism.

In aspects, the recessed lug roller of paragraph [0029], wherein the square edge recessed lug paver comprises at least five recessed lugs formed on the square edge recessed lug paver, each recessed lug including a depth equal to a proper joint size, a base from 0.3175 to 1.111 centimeters, a height that maintains proper joint size and is not visible when the square edge recessed lug paver is installed; and a shape that does not damage an adjacent square edge recessed lug paver and enhances safety during installation; a height of from 2.54 to 10.16 centimeters; a width; a length; a lugged side, the lugged side having a number of recessed lugs as calculated by a first recessed lug equation, where the recessed lugs of the lugged side are positioned horizontally along the lugged side such that at least one recessed lug will contact at least one adjacent square edge recessed lug paver and will not contact recessed lugs of a first and second width side of adjacent square edge recessed lug pavers when installed; a first width side, the first width side having a number of recessed lugs as calculated by a second recessed lug equation; a second width side, the second width side having a number of recessed lugs as calculated by the second recessed lug equation, wherein the recessed lug(s) of the first width side are placed horizontally along the first width side in a mirror location to the placement of the recessed lug horizontally along the second width side; and wherein the recessed lugs are centered vertically along the lugged side, the first width side, and the second width side; a non-lugged side, the non-lugged side containing no recessed lugs.

### FIGURES

FIG. 1a represents a conventional square edge paver.

FIG. 1b represents a conventional square edge lugged paver.

FIG. 1c represents a conventional relieved edge lugged paver.

FIG. 2a represents a perspective view of a square edge recessed lug paver having a width to length ratio of 1:2.

FIG. 2b represents a top down view of the square edge recessed lug paver having a width to length ratio of 1:2.

FIG. 2c represents a lugged side view of the square edge recessed lug paver having a width to length ratio of 1:2.

FIG. 2d represents a first width side view of the square edge recessed lug paver having a width to length ratio of 1:2.

FIG. 2e represents a perspective view of a square edge recessed lug paver having a width to length ratio of 1:1.

FIG. 2f represents a top down view of a square edge recessed lug paver having a width to length ratio of 1:1.

FIG. 2g represents a lugged side view of a square edge recessed lug paver having a width to length ratio of 1:1.

FIG. 2h represents a first width view of a square edge recessed lug paver having a width to length ratio of 1:1.

FIG. 2i represents a perspective view of a square edge recessed lug paver having a width to length ratio of 1:3.

FIG. 2j represents a top down view of a square edge recessed lug paver having a width to length ratio of 1:3.

FIG. 2k represents a lugged side view of a square edge recessed lug paver having a width to length ratio of 1:3.

FIG. 2l represents a first width view of a square edge recessed lug paver having a width to length ratio of 1:3.

FIG. 3a represents a front view of a recessed lug roller that forms recessed lugs of the square edge recessed lug paver.

FIG. 3b represents a side view of the recessed lug roller.

FIG. 3c is an exploded top view of a recessed portion of the recessed lug roller.

FIG. 4 represents a method of producing square edge recessed lug pavers.

FIG. 5a represents a perspective view of a square edge recessed lug paver having a width to length ratio of 1:2 having recessed lugs within 0.3175 centimeters from the top of the square edge recessed lug paver to 0.3175 centimeters from the bottom of the square edge recessed lug paver.

FIG. 5b represents a top down view of the square edge recessed lug paver having a width to length ratio of 1:2 having recessed lugs within 0.3175 centimeters from the top of the square edge recessed lug paver to 0.3175 centimeters from the bottom of the square edge recessed lug paver.

FIG. 5c represents a lugged side view of the square edge recessed lug paver having a width to length ratio of 1:2 having recessed lugs within 0.3175 centimeters from the top of the square edge recessed lug paver to 0.3175 centimeters from the bottom of the square edge recessed lug paver.

FIG. 5d represents a first width side view of the square edge recessed lug paver having a width to length ratio of 1:2 having recessed lugs within 0.3175 centimeters from the top of the square edge recessed lug paver to 0.3175 centimeters from the bottom of the square edge recessed lug paver.

FIG. 5e represents a perspective view of a square edge recessed lug paver having a width to length ratio of 1:1 having recessed lugs within 0.3175 centimeters from the top of the square edge recessed lug paver to 0.3175 centimeters from the bottom of the square edge recessed lug paver.

FIG. 5f represents a top down view of a square edge recessed lug paver having a width to length ratio of 1:1 having recessed lugs within 0.3175 centimeters from the top of the square edge recessed lug paver to 0.3175 centimeters from the bottom of the square edge recessed lug paver.

FIG. 5g represents a lugged side view of a square edge recessed lug paver having a width to length ratio of 1:1 having recessed lugs within 0.3175 centimeters from the top of the square edge recessed lug paver to 0.3175 centimeters from the bottom of the square edge recessed lug paver.

FIG. 5h represents a first width view of a square edge recessed lug paver having a width to length ratio of 1:1 having recessed lugs within 0.3175 centimeters from the top of the square edge recessed lug paver to 0.3175 centimeters from the bottom of the square edge recessed lug paver.

FIG. 5i represents a perspective view of a square edge recessed lug paver having a width to length ratio of 1:3 having recessed lugs within 0.3175 centimeters from the top of the square edge recessed lug paver to 0.3175 centimeters from the bottom of the square edge recessed lug paver.

FIG. 5j represents a top down view of a square edge recessed lug paver having a width to length ratio of 1:3 having recessed lugs within 0.3175 centimeters from the top of the square edge recessed lug paver to 0.3175 centimeters from the bottom of the square edge recessed lug paver.

FIG. 5k represents a lugged side view of a square edge recessed lug paver having a width to length ratio of 1:3 having recessed lugs within 0.3175 centimeters from the top of the square edge recessed lug paver to 0.3175 centimeters from the bottom of the square edge recessed lug paver.

FIG. 5l represents a first width view of a square edge recessed lug paver having a width to length ratio of 1:3 having recessed lugs within 0.3175 centimeters from the top of the square edge recessed lug paver to 0.3175 centimeters from the bottom of the square edge recessed lug paver.

### DETAILED DESCRIPTION

A square edge recessed lug paver having recessed lugs that produce consistent joint size during installation without the use of additional pieces of equipment, while maintaining a square edge is described. The equipment and method to produce the square edge recessed lug paver is also described, where the recessed lug roller forms the recessed lugs of the square edge recessed lug pavers. The recessed lug roller includes at least one recessed portion and at least two compressing portions. The recessed lugs are formed on an uncut slug after extrusion of the slug. As used herein all numerical values include measurement errors.

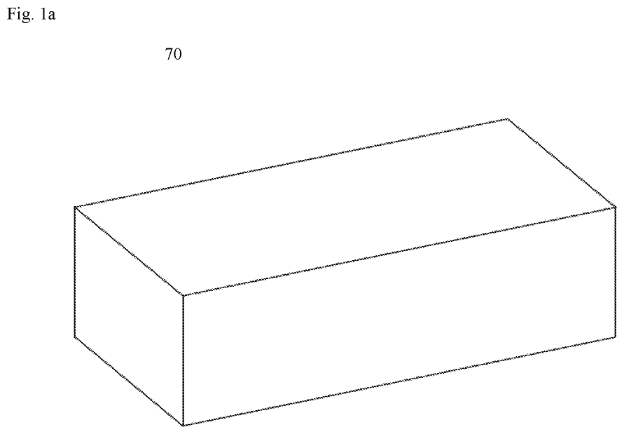

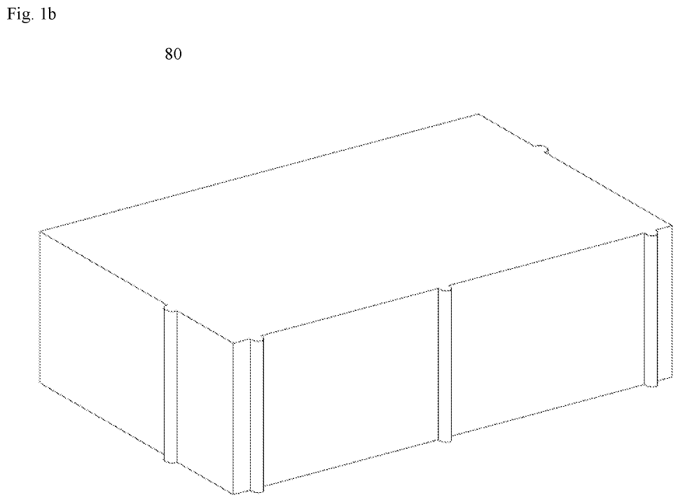

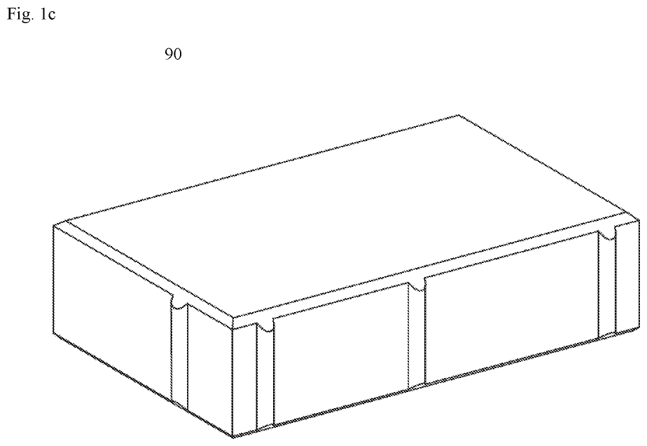

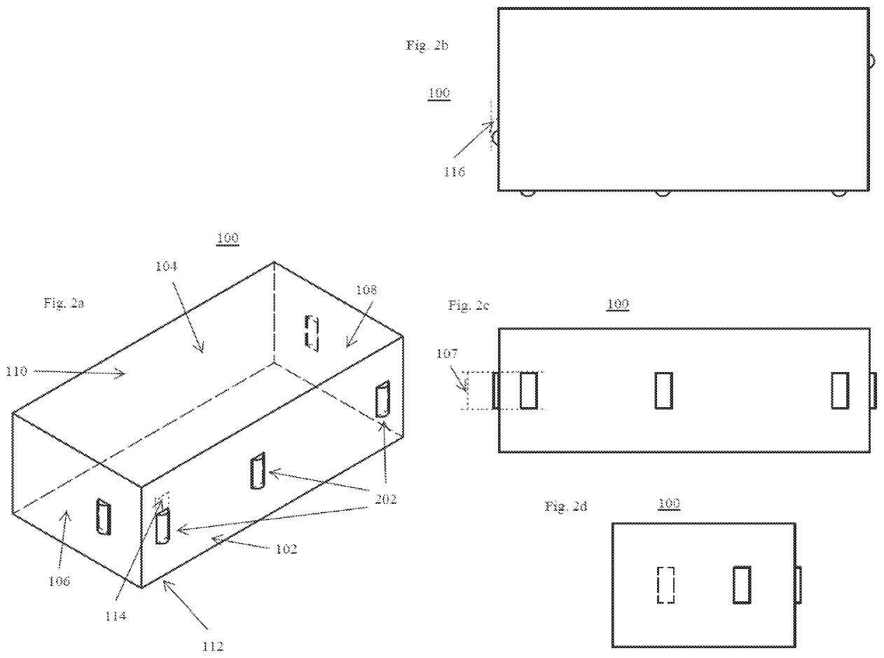

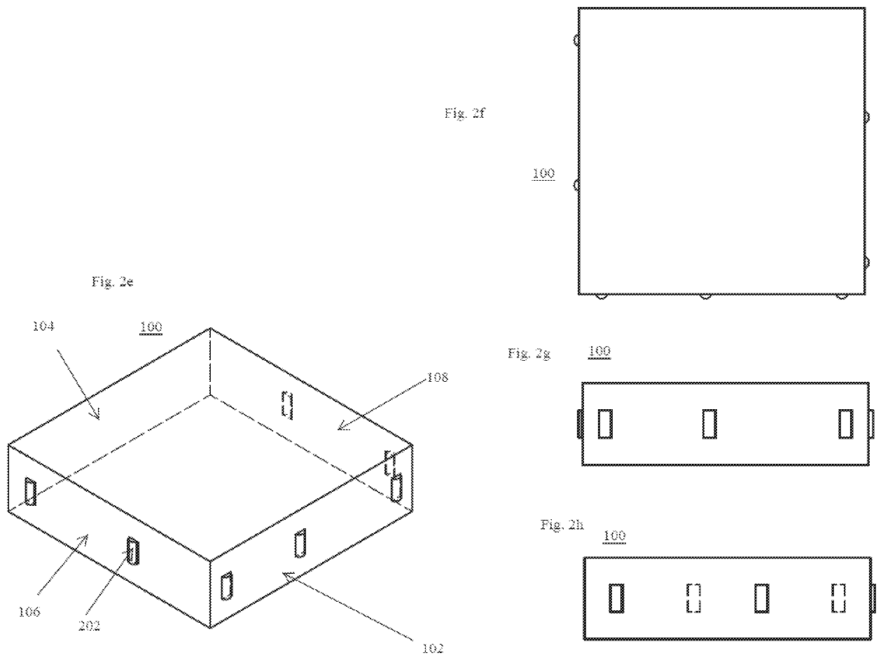

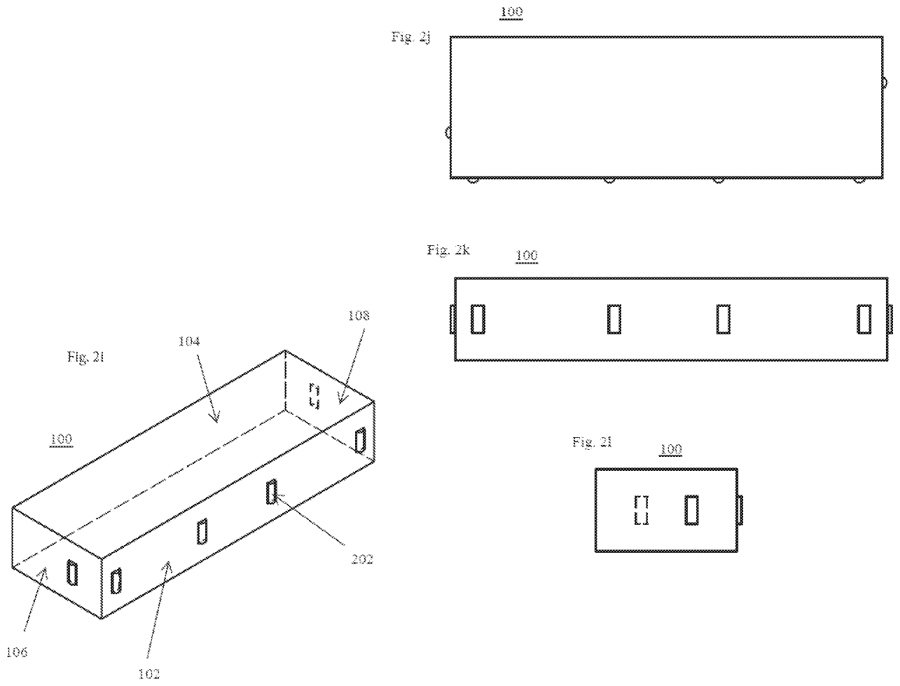

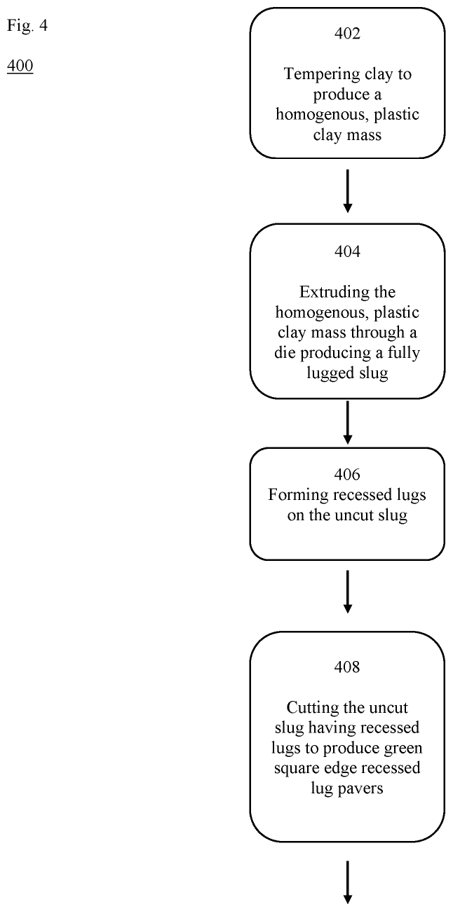

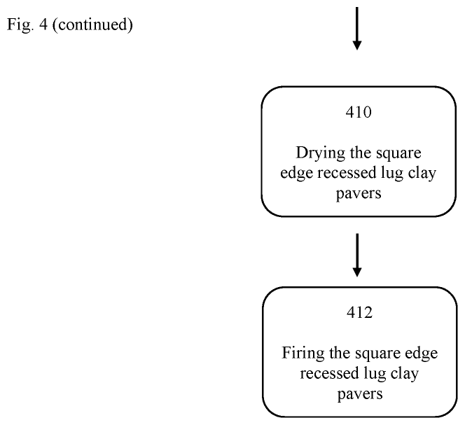

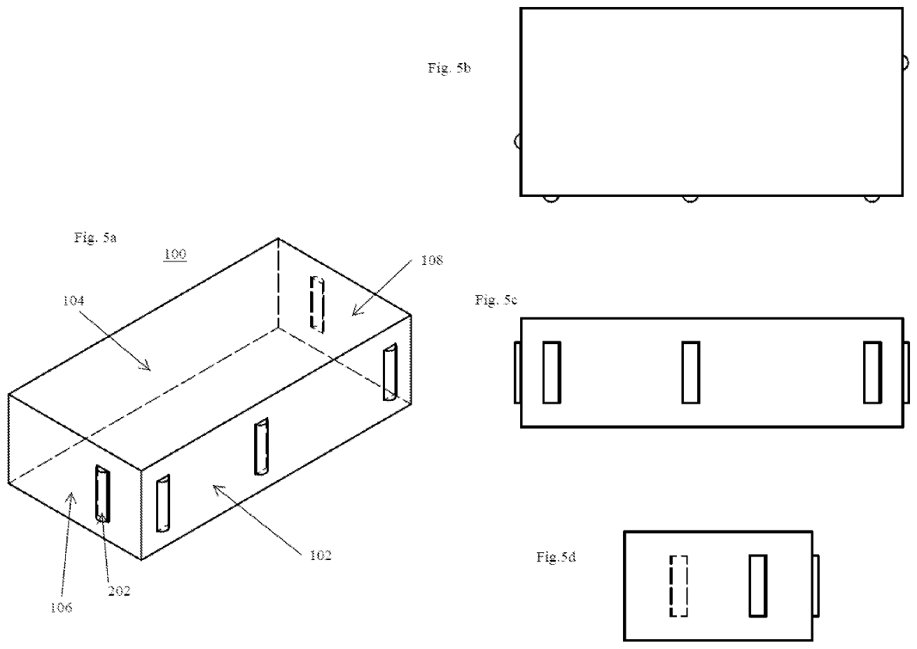

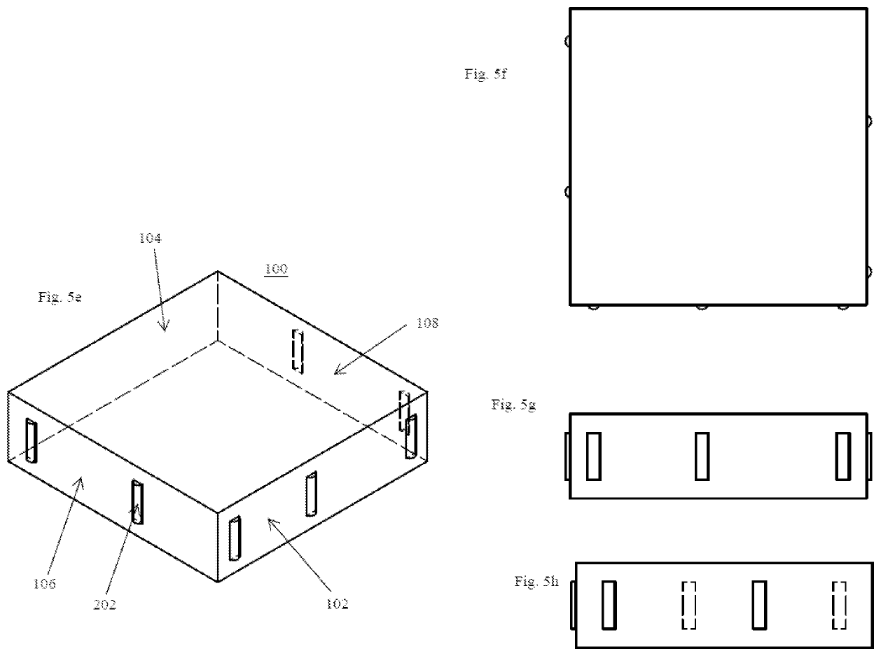

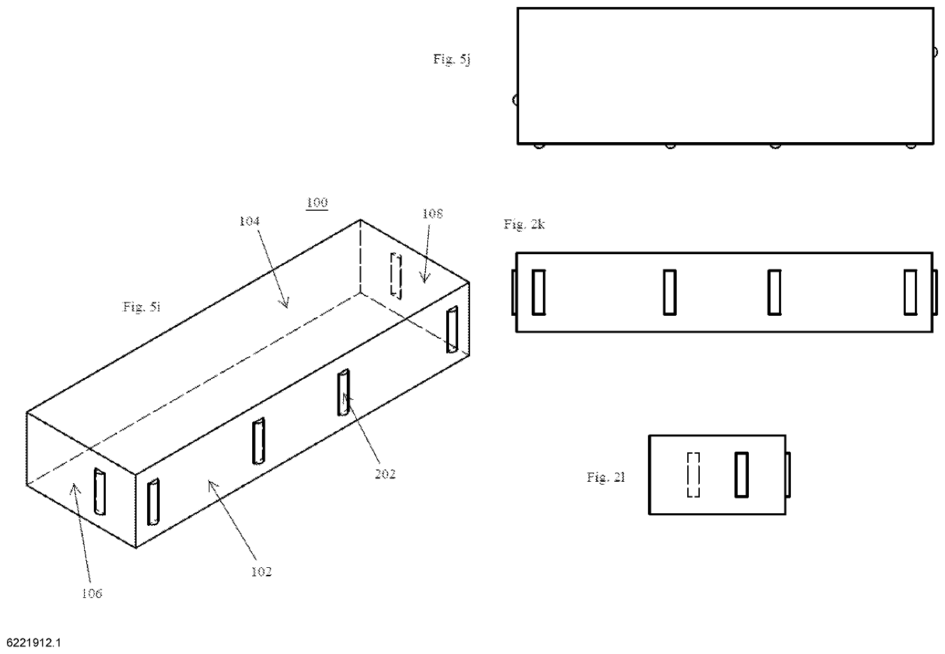

FIGS. 2a, 2e, 2i, 5a, 5e, and 5i represent perspective views of square edge recessed lug pavers. The square edge recessed lug paver is an extruded clay paver formed as described in FIG. 4. The square edge recessed lug paver 100 includes a lugged side 102, a non-lugged side 104, a first width side 106, and a second width side 108, a surface 110, and a bottom 112. The square edge recessed lug paver 100 may have dimensions of width to length in any ratio that permits use in connection with any bonding pattern, such as 1:1 (FIGS. 2e-2h and FIGS. 5e-5h), 1:2 (FIGS. 2a-2d and FIGS. 5a-5d), 1:3 (FIGS. 2i-2l and FIG. 5i-5l), or 1:4. The height of the square edge recessed lug paver 100 may be from 2.54 centimeters (cm) to 10.16 cm (1 inches to 4 inches).

The square edge recessed lug paver 100 includes at least five recessed lugs 202 attached to the square edge recessed lug paver 100. The recessed lugs 202 provide proper and consistent joint size when the square edge recessed lug pavers 100 are installed. Each of the recessed lugs 202 may be of any shape that provides proper joint size, such as a half cylinder, trapezoid, or rectangular with rounded edges. Each recessed lug 202 has a height 107 of from 1.27 to 2.54 cm (0.5 to 1 inches). Preferably, the height 107 of the recessed lug 202 is one third the height of the square edge recessed lug paver 100, for example, 1.905 cm (¾ inch). Each of the recessed lugs 202, may further have a height 107 of from 1.27 to 7.62 cm (0.5 to 1.25 inches). When the height 107 is from 1.27 to 7.62 cm, it is preferable for the height 107 of the recessed lugs 202 to be within 0.3175 cm (0.125 in.) from the top to 0.3175 cm (0.125 in.) from the bottom of the recessed lug paver 100, such that the recessed lug is not visible when installed. When the height 107 is from 1.27 to 7.62 cm, it is more preferable for the height 107 of the recessed lugs 202 to be within 1.27 cm (0.5 inch) from the top to (0.5 inch) from the bottom of the recessed lug paver 100. For example, the recessed lugs 202 may have a height 107 of 3.175 cm (1.25) inches when the height of the square edge recessed lug paver 100 is 5.715 (2.25 inches). The height 107 of the recessed lugs 202 and the placement of the recessed lugs 202 provides sufficient surface area contact with at least one adjacent square edge recessed lug paver 100 to maintain proper joint size along the entire height of the square edge recessed lug paver 100 while not being visible from the surface when installed.

A base 114 (i.e. portion of the recessed lug 202 attached to the square edge recessed lug paver 100) of the recessed lug 202 is from 0.3175 to 1.111 cm ( 2/16 to 7/16 inches). Preferably the base 114 of the recessed lug 202 at the base is 0.794 cm ( 5/16 inches). A depth 116, as measured from the deepest part of the recessed lug 202, of each recessed lug 202 is equal to the desired joint size, such as from 1.6 to 4.8 millimeters ( 1/16 to 3/16 inches). Preferably the depth 116 of each recessed lug 202 is 0.3175 cm (⅛ inch).

The shape and dimension of each of the recessed lugs 202 provide proper joint size, where the joint size is consistent (i.e. substantially the same) along the length and height of the square edge recessed lug paver 100. Further the shape and dimension of each of the recessed lugs 202 does not include a square (e.g. sharp) edge, such that when installed the recessed lugs 202 do not have a specific point of contact at a sharp edge to an adjacent paver, which reduces the likelihood of damage to an adjacent paver during installation. Moreover, the shape of each of the recessed lugs 202 enhances safety during installation, as the shape does not include sharp edges, which decreases the likelihood that an installer will be cut when contact with recessed lugs 202 occurs.

The lugged side 102 of the square edge recessed lug paver 100 includes at least 3 recessed lugs 202. The number of recessed lugs 202 on the lugged side 102 is determined by the length of the square edge recessed lug paver 100, where there are two recessed lugs 202 for the first four inches of the lugged side 102 and one recessed lug 202 for each four inches thereafter. This may be expressed as a first recessed lug equation, where the number of recessed lugs 202 on the lugged side is equal to the length divided by 10.16 when the length is in centimeters (4 when the length is in inches), plus 1, where if this is not a whole number, then the number of recessed lugs 202 is rounded down if the decimal portion of the number is equal to or less than 0.5 and rounded up if the decimal portion of the number is greater than 0.5. For example, square edge recessed lug pavers 100 that are 20.32 cm (8 inches) in length have three recessed lugs 202 on the lugged side 102 (see FIGS. 2a-2h and FIGS. 5a-5h), and square edge recessed lug pavers 102 that are 30.48 cm (12 inches) in length have four recessed lugs 202 (see FIGS. 2i-2l and FIGS. 5i-5l).

The number and placement of the recessed lugs 202 on the lugged side 102 provides that there is at least one recessed lug 202 from the lugged side 102 that contacts at least one adjacent square edge recessed lug paver 100. Additionally, the number and placement of the recessed lugs 202 on the lugged side 102 provides that the recessed lugs 202 will not contact the recessed lugs 202 either of the width sides 106 and 108 when used in any bonding pattern.

The recessed lugs 202 of the lugged side 102 that are closest to the first and second width sides 106 and 108, are 0.15875 to 10.16 cm ( 1/16-4 inches) from the respective corners of the square edge recessed lug paver 100, as measured from the midline of the recessed lugs 202. Preferably, the recessed lugs 202 of the lugged side 102 that are closest to the first and second width sides 106 and 108 are 1.5875 cm (⅝ inch) from the respective corners of the square edge recessed lug paver 100, as measured from the midline of the recessed lugs 202.

The middle recessed lug(s) 202 on the lugged side 102, are placed in a position to allow use in any bonding pattern, such as running bond, basket weave, and herringbone patterns, such as from 6.35 to 10.795 cm (2.5 to 4.25 inches) from each immediately adjacent recessed lug 202 on the lugged side of the square edge recessed lug paver 100. For example, for a lugged side 102 that is 20.32 cm (8 inches) in length the middle recessed lug is placed 7.3025 cm (2.875 inches) from the recessed lug closest to the first width side 106, as measured from the midlines of the recessed lugs, and from 9.525 cm (3.75 inches) from the recessed lug closest to the second width side 108, as measured from the midlines of the recessed lugs (see FIGS. 2a-2h and FIGS. 5a-5h). Or for example, for a lugged side 102 that is 30.48 cm (12 inches) in length, the middle recessed lug 202 that is adjacent to the recessed lug 202 closest to the first width side 106 is placed 9.525 cm (3.75 inches) from the same, and the middle recessed lug 202 that is adjacent to the recessed lug 202 closest to the second with side 108 is 9.8425 cm (3.875 inches) from the same, and the middle recessed lugs 202 are 7.62 cm (3 inches) apart, all as measured from the midlines of the recessed lugs 202 (see FIGS. 2i-2l and FIGS. 5i-5l).

The non-lugged side 104 of the square edge recessed lug paver 100 does not contain any recessed lugs as this allows the square edge recessed lug paver to be placed adjacent to the lugged side 102 of an adjacent square edge recessed lug paver 100.

The first width side 106 and the second width side 108 of the square edge recessed lug paver 100 have at least one recessed lug 202 each, where there is one recessed lugs 202 for the first 10.16 cm (4 inches) of the first and second with sides 106 and 108 and one recessed lug 202 for each 10.16 cm (4 inches) thereafter. This may be expressed as a second recessed lug equation, where the number of recessed lugs 202 on either the first or second width side 106 and 108 is equal to the length divided by 10.16 when the length is in centimeters (4 when the length is in inches) where if this is not a whole number the number of recessed lugs is rounded down if the decimal portion of the number is equal to or less than 0.5 and rounded up if the decimal portion of the number is greater than 0.5. For example, square edge recessed lug pavers 100 having a width of 10.16 cm (4 inches) have one recessed lug 202 on each first and second width sides 106 and 108 (see FIGS. 2a-2h and FIGS. 5a-5h). And for example, square edge recessed lug pavers 100 having a width of 20.32 cm (8 inches) have two recessed lugs 202 on each first and second width sides 106 and 108 (see FIGS. 2i-2l and FIGS. 5i-5l).

The recessed lugs 202 of the first and second width sides 106 and 108 are placed on each respective width side in a position to allow any bonding pattern, such as running bond, basket weave, and herringbone patterns without contacting recessed lugs of adjacent pavers. For example, the recessed lugs are placed from 1.27 to 8.255 (0.5 to 3.25 inches) from one of the lugged or non-lugged sides 102 and 104, and from 1.27 to 8.255 (0.5 to 3.25 inches) from the other of the lugged or non-lugged sides 102 and 104, both as measured from the midlines of the recessed lugs 202. The recessed lugs 202 of the first and second width sides 106 and 108 are mirrors of each other, where for example, if the recessed lug 202 on the first width side 106 is placed 2.8575 cm from the lugged side 102, then the recessed lug 202 on the second width side 108 is placed 2.8575 cm from the non-lugged side 104 (see FIGS. 2a-2h and FIGS. 5a-5h), as measured from the midline. The placement of the recessed lugs 202 may also be reversed on the first and second width sides 106 and 108. Placement of the recessed lugs 202 on the first and second width sides 106 and 108 as mirrors allows the square edge recessed lug paver 100 to be flipped over (such that the surface 110 becomes the bottom 112) for use in a bonding pattern.

For example, for first and second width sides 106 and 108 having one recessed lug 202, the recessed lug 202 on the first width side 106 is placed 2.8575 cm from the lugged side 102, and the recessed lug 202 on the second width side 108 is placed 2.8575 cm from the non-lugged side 104 (see FIGS. 2a-2h and FIGS. 5a-5h). For further example, for first and second width sides 106 and 108 having two recessed lugs 202, the recessed lugs 202 on the first width side 106 are placed 7.62 cm (3 inches) from the lugged side 102 and 2.222 cm (0.875 inches) from the non-lugged side 104, respectively. And the recessed lugs 202 on the second width side 108 are placed 7.62 cm (3 inches) from the non-lugged side 104 and 2.222 cm (0.875 inches) from the lugged side 102, respectively (see FIGS. 2i-2l and FIG. 5i-5l). All measurements in this paragraph are as measured from the midline of the recessed lugs 202.

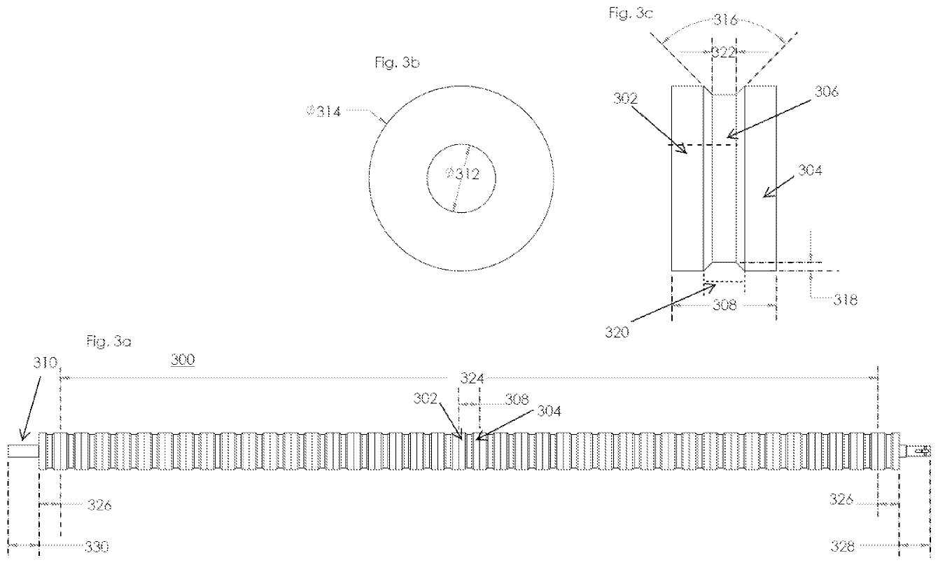

FIG. 3a represents a front view of a recessed lug roller 300 that forms recessed lugs 202 of the square edge recessed lug paver 100. The recessed lug roller 300 is retrofitted to conventional extruded paver equipment. As described in FIG. 4, the at least 5 recessed lugs 202 are formed in 406, when the clay is in a green state. The recessed lug roller 300 is configured for recessed lug 202 formation through compression of full lugs on an uncut slug. The recessed lug roller 300 is formed from a material that retains form during and after compression of the uncut slug, such as mild steel, hardened steel, plastic composites, or nylon and the like.

The recessed lug roller 300 includes at least one roller section 308, two clearance sections 326, and a shaft 310. The recessed lug roller may include 39 roller sections 308, as represented by 324. The roller sections 308 may be fabricated as a single piece, or the roller sections 308 may be attached through fabrication. Each roller section 308 is a length substantially equal to the height of the green square edge recessed lug paver 100. For example, when square edge recessed lug pavers 100 have a height from 5.715 (2.25 inches), the length of each roller section 308 is 6.126 cm (2.412 inches). Green square edge recessed lug pavers 100 lose approximately 7% of size during the drying and firing of the process, which is known to those skilled in the art.

Each roller section 308 includes a first compression portion 302, a second compression portion 304, a recessed portion 306. The first compression portion 302 and the second compression portion 304 compress a portion of the extruded full lugs on the uncut slug to form the recessed lugs 202, in connection with the recessed portion 306, where the recessed portion 306 does not compresses any of the length of the extruded full lug.

The first and second compression portions 302 and 304, compress a top and a bottom of each extruded full lug. When two or more roller sections 308 form the recessed lug roller 300, a second compression portion 304 of a first roller section 308 contacts a first compression portion 302 of a second roller section 308. When the recessed lug roller 300 includes two or more roller sections 308 the number of square edge recessed lug pavers 100 that simultaneously undergo recessed lug 202 formation is equal to the number of roller sections 308 plus the clearance sections 326.

The recessed portion 306 of each roller section 308 is configured for forming the recessed lugs 202 in connection with the first and second compression portions 302 and 304. Each recessed portion 306 does not compress the full lugs to form the recessed lugs 202, allowing the uncompressed portion of the full lug to retain the shape of the full lug from the die used to extrude the slug (as described in 404). The dimensions of each recessed portion 306 are described in FIG. 3c.

The two clearance sections 326 of the recessed lug roller 300 are the same as the roller sections, 308, however, the compression portions closest to the either end of the recessed lug roller 300 include additional length (i.e. at least from 0.12192 cm (0.048 inches) or greater). The additional length runs over a waste piece on either end of the uncut slug being processed by the recessed lug roller 300. This additional length also ensures that recessed lugs 202 are formed on each end of the uncut slug in instances where placement of the slug on the cutting table is slightly misaligned.

The shaft 310 of the recessed lug roller 300 is configured to allow circular movement of the recessed lug roller 300 across the uncut slug forming the recessed lugs 202. The shaft 310 is further configured for attachment to conventional paver extrusion equipment that provides the power and movement of the recessed lug roller 300 across the uncut slug. The first and second side of the shaft 328 and 330 are configured for attachment to a drive mechanism of the conventional paver extrusion equipment.

The recessed lug roller 300 may further be configured for attachment of adjustable support brackets. The conventional adjustable support brackets assist in providing rigidity and reducing flex in the recessed lug roller 300 during recessed lug 202 formation. For example, the recessed lug roller 300 may be configured for attachment of the adjustable support brackets to roller sections 308 that are modified to allow attachment of the adjustable support brackets to locations that are one-third and two-thirds along the recessed lug roller 300. The square edge recessed lug pavers 100 that are formed from these modified roller sections 308 are discarded.

FIG. 3b represents a side view of the recessed lug roller. FIG. 3b shows a shaft diameter 312. The shaft diameter 312 is from 2 to 6 cm (0.787 to 1.576 inches). Preferably shaft diameter 312 is 4 cm (1.575 inches). FIG. 3b also shows a recessed lug roller diameter 314, which is measured from the first and second compression portions 302 and 304. The recessed lug roller diameter 314 is from 8.89 to 12.7 cm (3.5 to 5 inches). Preferably, the recessed lug roller diameter 314 is 10.795 cm (4.25 inches).

FIG. 3c is an exploded top view of a recessed portion 306 of the recessed lug roller 300. The dimension of the recessed portion 306 produces the recessed lugs 202 in a green state, where upon completion of production (as described in FIG. 4), the recessed lugs 202 will have the dimensions described in FIGS. 2a-2l. Green square edge recessed lug pavers 100, including the recessed lugs 202, lose approximately 7% of size during the formation process, which is known to those skilled in the art.

The recessed portion 306 has a shape to accommodate the shape of the recessed lug 202 (i.e. the half circle, trapezoid, or rounded rectangle maintains the shape and form of the die the slug was extruded from in 404). For example, the recessed portion 306 may have a tapered shape, which tapers from an opening 320 of the recessed portion 306 at a 90 degree angle, as shown by 316 in FIG. 3c. A recessed portion depth 318 is equal to the depth 116 of the recessed lugs 202 in a green state plus a margin (i.e. from 0.01 to 10 centimeters), such that the recessed portion does not compress the recessed lug 202 to shorten its depth 116. For example, the recessed portion depth 318 may be 0.4053 cm (0.1596 inches). The opening 320 of the recessed portion 306 is equal to the height 107 of the recessed lugs 202 in a green state. A width 322 of the recessed portion 306 accommodates the shape of the recessed lug 202 without compressing the recessed lug 202 in a green state (i.e. the half circle, trapezoid, or rounded rectangle maintains the shape and form of the die the slug was extruded from in 404). For example, the width 322 of the recessed portion 306 may be 1.397 cm (0.550 inches).

FIG. 4 represents a method of producing square edge recessed lug pavers 100. In 402, clay is tempered to produce a homogenous, plastic clay mass. Conventional mechanisms are used to temper the clay, such as through mixing with water in a pug mill. Water is mixed with the clay in an amount that is sufficient for extrusion, such as from 10% to 15%. Upon completion of the pugging the homogenous, plastic clay mass is de-aired in a conventional deairing chamber.

In 404, the homogenous, plastic clay mass is extruded through a die producing a fully lugged slug. The extrusion die may be a conventional extrusion die having lugs to produce the fully lugged slug.

In 406, recessed lugs 202 are formed on the uncut slug. The recessed lugs 202 are formed on the uncut slug via two recessed lug rollers 300. One or more recessed lug rollers 300 contacts the lugged side 102, and the first and second width sides 106 and 108 perpendicularly to form the recessed lugs 202. For example, the recessed lugs 202 are formed on the uncut slug via two recessed lug rollers 300. The first recessed lug roller 300 contacts the lugged side 102, perpendicularly, forming the recessed lugs 202 on the lugged side 102, where the uncut slug is pushed underneath the first recessed lug roller 300. The first and second recessed lug rollers 300 then simultaneously contact the first and second width sides 106 and 108 perpendicularly, forming the recessed lugs 202 on the first and second width sides 106 and 108, where the uncut slug is pushed up between the first and second recessed lug rollers.

In 408, the uncut slug is cut, forming green, square edge recessed lug pavers 100 having recessed lugs 202. The cutting is through conventional mechanisms, such as using an automatic cutter.

In 410, the green, square edge recessed lug pavers are dried using conventional mechanisms. In 412, the square edge recessed lug pavers are fired using conventional mechanisms producing final square edge recessed lug pavers.

1. A square edge recessed lug paver for maintaining proper joint size in any bonding pattern, the square edge recessed lug paver comprising:
at least five recessed lugs formed on the square edge recessed lug paver, each recessed lug comprising
a depth equal to a proper joint size,
a base from 0.3175 to 1.111 centimeters,
a height that maintains proper joint size and is not visible when the square edge recessed lug paver is installed; and
a shape that does not damage an adjacent square edge recessed lug paver and enhances safety during installation;
a height of from 2.54 to 10.16 centimeters;
a width;
a length;
a lugged side, the lugged side having a number of recessed lugs as calculated by a first recessed lug equation, where the recessed lugs of the lugged side are positioned horizontally along the lugged side such that at least one recessed lug will contact at least one adjacent square edge recessed lug paver and will not contact recessed lugs of a first and second width side of adjacent square edge recessed lug pavers when installed;
a first width side, the first width side having a number of recessed lugs as calculated by a second recessed lug equation;
a second width side, the second width side having a number of recessed lugs as calculated by the second recessed lug equation, wherein
the recessed lug(s) of the first width side are placed horizontally along the first width side in a mirror location to the placement of the recessed lug horizontally along the second width side; and
wherein the recessed lugs are centered vertically along the lugged side, the first width side, and the second width side;
a non-lugged side, the non-lugged side containing no recessed lugs.

2. The square edge recessed lug paver of claim 1, wherein
the height is from 3.81 to 10.16 centimeters, and the recessed lug height is equal to one third of the height.

3. The square edge recessed lug paver of claim 1, wherein
the height is from 2.54 to 10.16 centimeters and the recessed lug height is within 0.3175 centimeters from a top of the square edge recessed lug paver to 0.3175 centimeters from a bottom of the square edge recessed lug paver.

4. The square edge recessed lug paver of claim 1, wherein
the height is from 3.81 to 10.16 centimeters and the recessed lug height is 1.27 centimeters from a top of the square edge recessed lug paver to 1.27 centimeters from a bottom of the square edge recessed lug paver.

5. The square edge recessed lug paver of claim 1, wherein
the width to length ratio is 1:1.

6. The square edge recessed lug paver of claim 5, wherein
the width and length are 20.32 centimeters, and wherein
the lugged side has three recessed lugs and the first and second width sides each have two recessed lugs.

7. The square edge recessed lug paver of claim 1, wherein
the width to length ratio is 1:2.

8. The square edge recessed lug paver of claim 7, wherein
the width is 10.16 centimeters and the length is 20.32 centimeters, and wherein
the lugged side has three recessed lugs and the first and second sides each have one recessed lug.

9. The square edge recessed lug paver of claim 1, wherein
the width to length ratio is 1:3.

10. The square edge recessed lug paver of claim 9, wherein
the width is 10.16 centimeters and the length is 30.48 centimeters, and wherein
the lugged side has four recessed lugs and the first and second sides each have one recessed lug.

11. The square edge recessed lug paver of claim 1, wherein
the width to length ratio is 1:4.

12. The square edge recessed lug paver of claim 11, wherein
the width is 10.16 centimeters and the length is 40.64 centimeters, and wherein
the lugged side has five recessed lugs and the first and second sides each have one recessed lug.

13. A recessed lug roller that forms recessed lugs on square edge recessed lug pavers, the recessed lug roller comprising:
at least one roller section, the at least one roller section having a length equal to a height of the green square edge recessed lug paver, the at least one roller section comprising
a first compression portion and a second compression portion that compress full lugs of a green square edge recessed lug paver;
a recessed portion configured for forming recessed lugs of the square edge recessed lug paver where the recessed lug when green is not compressed by the recessed portion, the recessed portion comprising
an opening equal to the height of the recessed lugs when green;
a depth to accommodate the depth of the recessed lugs when green; and
a shape to accommodate the shape of the recessed lug when green; and
two clearance sections on each end of the recessed lug roller; and
a shaft configured to allow the recessed lug roller to move in a circular motion across an uncut slug, where a first side and second side of the shaft are configured for attachment to a drive mechanism.

14. The recessed lug roller of claim 13, further comprising
two or more roller sections, where a first compression portion of a first roller section is fabricated to a second compression portion of a second roller section.

15. The recessed lug roller of claim 13, further comprising
thirty-nine roller sections, where each first compression portion is fabricated to a second compression portion of an adjacent roller section.

16. The recessed lug roller of claim 13, wherein
the recessed portion has a tapered shape that tapers at a 90 degree angle from the opening of the recessed portion.

17. The recessed lug roller of claim 13 further comprising
adjustable support brackets, where two rollers sections at locations one-third and two-thirds along the recessed lug roller are configured for attachment of the adjustable support brackets.

18. A method of forming a square edge recessed lug paver without use of additional pieces of equipment, the method comprising:
tempering clay to produce a homogenous, plastic clay mass;
extruding the homogenous, plastic clay mass through a die having lugs to produce a fully lugged slug;
forming recessed lugs on the fully lugged uncut slug;
cutting the uncut slug having recessed lugs to produce green, square edge recessed lug payers having recessed lugs;
drying the green square edge recessed lug clay payers;
firing the square edge recessed lug clay paver to produce square edge recessed lug payers.

19. The method of claim 18, wherein
the recessed lug roller comprises
at least one roller section, the at least one roller section having a length equal to a height of the green square edge recessed lug paver, the at least one roller section comprising
a first compression portion and a second compression portion that compress full lugs of a green square edge recessed lug paver;
a recessed portion configured for forming recessed lugs of the square edge recessed lug paver where the recessed lug when green is not compressed by the recessed portion, the recessed portion comprising
an opening equal to the height of the recessed lugs when green;
a depth to accommodate the depth of the recessed lugs when green; and
a shape to accommodate the shape of the recessed lug when green; and
two clearance sections on each end of the recessed lug roller; and
a shaft configured to allow the recessed lug roller to move in a circular motion across the green square edge recessed lug pavers, where a first side and a second side of the shaft are configured for attachment to a drive mechanism.

20. The method of claim 18, wherein
the square edge recessed lug paver comprises at least five recessed lugs formed on the square edge recessed lug paver, each recessed lug comprising
a depth equal to a proper joint size,
a base from 0.3175 to 1.111 centimeters,
a height that maintains proper joint size and is not visible when the square edge recessed lug paver is installed; and
a shape that does not damage an adjacent square edge recessed lug paver and enhances safety during installation;
a height of from 2.54 to 10.16 centimeters;
a width;
a length;
a lugged side, the lugged side having a number of recessed lugs as calculated by a first recessed lug equation, where the recessed lugs of the lugged side are positioned horizontally along the lugged side such that at least one recessed lug will contact at least one adjacent square edge recessed lug paver and will not contact recessed lugs of a first and second width side of adjacent square edge recessed lug pavers when installed;
a first width side, the first width side having a number of recessed lugs as calculated by a second recessed lug equation;
a second width side, the second width side having a number of recessed lugs as calculated by the second recessed lug equation, wherein
the recessed lug(s) of the first width side are placed horizontally along the first width side in a mirror location to the placement of the recessed lug horizontally along the second width side; and
wherein the recessed lugs are centered vertically along the lugged side, the first width side, and the second width side;
a non-lugged side, the non-lugged side containing no recessed lugs.
